(19) United States
(12) Patent Application Publication
(10) Pub. No.: US 2025/0135610 A1
(43) Pub. Date: May 1, 2025

(54) POWERED RATCHET TOOL WITH MULTI-PIECE CRANKSHAFT ASSEMBLY

(71) Applicant: MILWAUKEE ELECTRIC TOOL CORPORATION, Brookfield, WI (US)

(72) Inventors: Joseph Jurss, Brookfield, WI (US); Benjamin J. Skelton, Milwaukee, WI (US)

(21) Appl. No.: 18/930,794

(22) Filed: Oct. 29, 2024

Related U.S. Application Data
(60) Provisional application No. 63/594,326, filed on Oct. 30, 2023.

(51) Int. Cl. B25B 21/00

(52) U.S. Cl. CPC B25B 21/004

(57) ABSTRACT

A powered ratchet tool includes a housing, a head portion of the housing, a drive assembly, a yoke supported within the head portion, an anvil, a pawl, and a shaft assembly. The drive assembly includes an output rotatable about a first axis. The yoke is pivotable about a second axis perpendicular to the first axis. The anvil extends from the head portion and is configured to engage a socket. The pawl is moveable between a first and a second position to switch the direction of rotation of the anvil. The shaft assembly extends between the output and the yoke and is formed as a multi-piece construction. The shaft assembly includes a shaft extending along the first axis, a first coupler fixed to a first end of the shaft, a second coupler fixed to the second end of the shaft, and a pin extending from the second coupler to the yoke.

### CROSS-REFERENCE TO RELATED APPLICATIONS

This application claims priority to co-pending U.S. Provisional Application No. 63/594,326, filed Oct. 30, 2023, the entire content of which is incorporated herein by reference.

### FIELD

The present invention relates to power tools and, more particularly, to powered ratchet tools.

### BACKGROUND

The present disclosure relates to a powered ratchet wrench for applying torque to a fastener for tightening or loosening the fastener.

Powered ratchet tools are typically powered by an electrical source, such as a DC battery, a conventional AC source, or by pressurized air. Powered ratchet tools are constructed of components such as a motor, a drive assembly driven by the motor, and an output for applying torque to a fastener.

### SUMMARY

In some aspects, the techniques described herein relate to a powered ratchet tool including: a housing including a head portion; a drive assembly including an output rotatable about a first axis; a yoke supported within the head portion and pivotable about a second axis perpendicular to the first axis; an anvil extending from the head portion and configured to engage a socket; a pawl moveable between a first position, in which the pawl couples the anvil for co-rotation with the yoke in a first direction about the second axis, and a second position, in which the pawl couples the anvil for co-rotation with the yoke in a second direction about the second axis; and a shaft assembly extending between the output of the drive assembly and the yoke, the shaft assembly formed as a multi-piece construction, the shaft assembly including: a shaft extending along the first axis and having a first end and a second end opposite the first end, a first coupler fixed to the first end of the shaft, the first coupler configured to couple the shaft assembly for co-rotation with the output of the drive assembly about the first axis, a second coupler fixed to the second end of the shaft, and a pin extending from the second coupler to the yoke, wherein the pin is offset from the first axis such that rotation of the shaft assembly about the first axis causes reciprocation of the yoke about the second axis.

In some aspects, the techniques described herein relate to a powered ratchet tool, wherein the first coupler is made of powdered metal.

In some aspects, the techniques described herein relate to a powered ratchet tool, wherein the second coupler is made of powdered metal.

In some aspects, the techniques described herein relate to a powered ratchet tool, wherein the drive assembly includes a motor and a planetary transmission and wherein the output is a carrier of the planetary transmission.

In some aspects, the techniques described herein relate to a powered ratchet tool, wherein the first coupler includes a spline, and wherein the spline is received within the carrier of the planetary transmission.

In some aspects, the techniques described herein relate to a powered ratchet tool, wherein the shaft is made of chromoly steel.

In some aspects, the techniques described herein relate to a powered ratchet tool, wherein the yoke receives a bushing, and wherein the bushing receives the pin of the shaft assembly.

In some aspects, the techniques described herein relate to a powered ratchet tool, wherein the second coupler includes a recess to receive the pin, a first wing, and a second wing, wherein the recess is formed at least partially in the second wing, and wherein the first wing and the second wing are sized differently so the first axis intersects a center of mass of the second coupler.

In some aspects, the techniques described herein relate to a powered ratchet tool including: a housing including a head portion; a drive assembly; a yoke supported within the head portion; and a shaft assembly extending between an output of the drive assembly and the yoke, the shaft assembly including: a shaft extending along a first axis and having a first end and a second end opposite the first end, the shaft formed by a first manufacturing process, a first coupler fixed to the first end of the shaft, the first coupler configured to couple the shaft assembly for co-rotation with the output of the drive assembly, the first coupler formed by a second manufacturing process, and a second coupler fixed to the second end of the shaft, the second coupler formed by a third manufacturing process, wherein at least one of the second manufacturing process or the third manufacturing process is different than the first manufacturing process.

In some aspects, the techniques described herein relate to a powered ratchet tool, wherein the shaft assembly includes a pin extending from the second coupler, wherein the pin is offset from the first axis such that rotation of the shaft assembly about the first axis causes reciprocation of the yoke about a second axis.

In some aspects, the techniques described herein relate to a powered ratchet tool, wherein at least one of the second manufacturing process or the third manufacturing process is a powdered metal manufacturing process.

In some aspects, the techniques described herein relate to a powered ratchet tool, wherein the second manufacturing process and the third manufacturing process are the same manufacturing processes.

In some aspects, the techniques described herein relate to a powered ratchet tool, wherein the first coupler and the second coupler have a different hardness than the shaft.

In some aspects, the techniques described herein relate to a powered ratchet tool, wherein the first manufacturing process includes machining.

In some aspects, the techniques described herein relate to a powered ratchet tool, wherein the shaft is made of chromoly steel.

In some aspects, the techniques described herein relate to a powered ratchet tool including: a housing including a head portion; a drive assembly including an output rotatable about a first axis; a yoke supported within the head portion and pivotable about a second axis perpendicular to the first axis; an anvil extending from the head portion and configured to engage a socket; a pawl moveable between a first position, in which the pawl couples the anvil for co-rotation with the yoke in a first direction about the second axis, and a second position, in which the pawl couples the anvil for co-rotation with the yoke in a second direction about the second axis; and a shaft assembly extending between the output of the drive assembly and the yoke, the shaft assembly formed as a multi-piece construction, the shaft assembly including: a shaft extending along the first axis and having a first end and a second end opposite the first end, a first coupler configured to couple the shaft assembly for co-rotation with the output of the drive assembly about the first axis, a second coupler, and a pin extending from the second coupler to the yoke, wherein the pin is offset from the first axis such that rotation of the shaft assembly about the first axis causes reciprocation of the yoke about the second axis, wherein the shaft is made of a first material, and wherein at least one of the first coupler or the second coupler is made of a second material different than the first material.

In some aspects, the techniques described herein relate to a powered ratchet tool, wherein the shaft is made of forged steel.

In some aspects, the techniques described herein relate to a powered ratchet tool, wherein both the first coupler and the second coupler are made of the second material.

In some aspects, the techniques described herein relate to a powered ratchet tool, wherein the pin is made of forged steel.

In some aspects, the techniques described herein relate to a powered ratchet tool, wherein the drive assembly includes a motor and a planetary transmission, wherein the output is a carrier of the planetary transmission, wherein the first coupler includes a spline, wherein the spline is received within the carrier of the planetary transmission, and wherein the shaft is pressed into a recess of the first coupler.

Other features and aspects of the disclosure will become apparent by consideration of the following detailed description and accompanying drawings.

### BRIEF DESCRIPTION OF THE DRAWINGS

FIG. 1 is a perspective view of a powered ratchet tool embodying aspects of the present disclosure.

FIG. 2 is a cross-sectional view of the powered ratchet tool of FIG. 1, taken along line A-A in FIG. 1.

FIG. 3 is a cross-sectional view of the powered ratchet tool of FIG. 2, taken along line B-B in FIG. 1

FIG. 4 is a perspective view of a crankshaft assembly of the powered ratchet tool of FIG. 1.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

### DETAILED DESCRIPTION

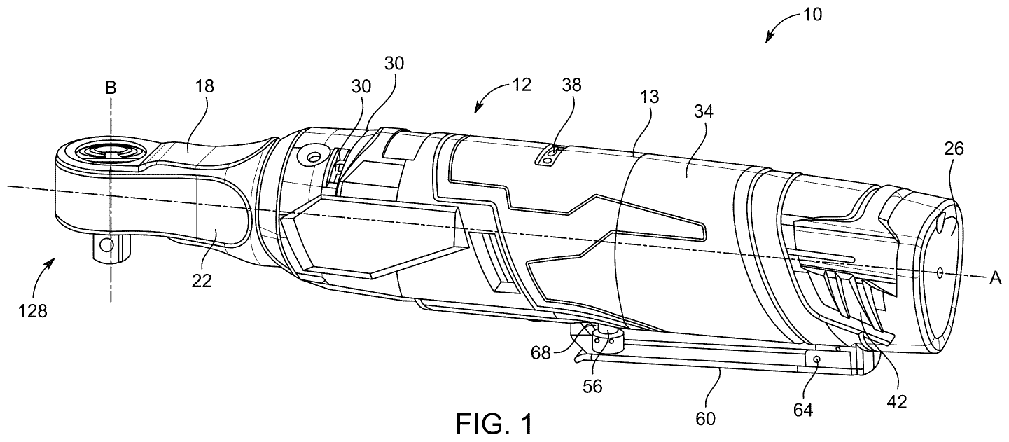

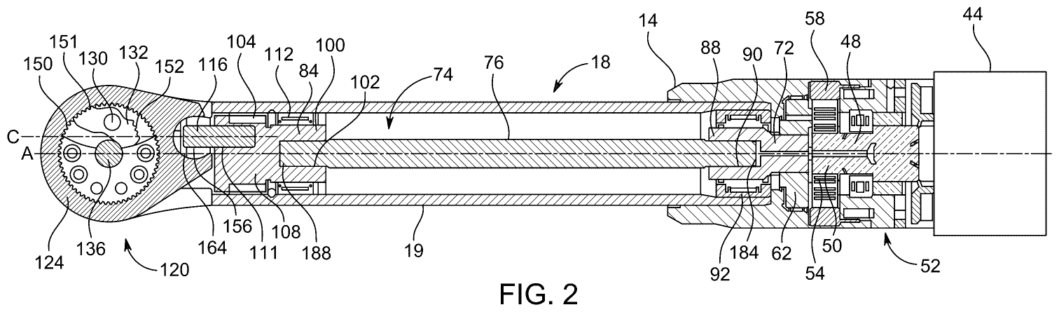

FIG. 1 illustrates a powered ratchet tool 10 including a housing 12 defining a longitudinal center axis A. In the illustrated embodiment, the housing 12 includes a handle portion 13, a drive housing 14 coupled to and supported by the handle portion 13, and a head portion 18 extending from the drive housing 14. In some embodiments, the head portion 18 may include an elongated tubular section 19 to provide the powered ratchet tool 10 with an extended reach (e.g., FIG. 2). In other embodiments, the elongated tubular section 19 may be omitted or shortened to provide the ratchet tool 10 with a more compact form (e.g., FIG. 1). The illustrated handle portion 13 includes a pair of clamshell halves 30. The handle portion 13 also includes a grip 34 that is formed by a resilient material such as rubber or silicone and which is overmolded on the clamshell halves 30. The handle portion 13 is configured to be grasped by a user during use of the ratchet tool 10.

With continued reference to FIG. 1, a battery pack 26 is removably coupled to the housing 12 and, in the illustrated embodiment, is received by the handle portion 13. In particular, the battery pack 26 can be inserted into and removed from a cavity in the handle portion 13 in a direction along the axis A. An indicator 38 supported by the handle portion 13 displays a charge level of the battery pack 26. The battery pack 26 includes a latch 42, which retains the battery pack 26 within the cavity and which can be actuated (e.g., depressed) to release the battery pack 26 from the ratchet tool 10. The illustrated battery pack 26 is a removable and rechargeable 12-volt battery pack and includes three (3) Lithium-ion battery cells. In other constructions, the battery pack 26 may include fewer or more battery cells, different chemistries, and/or different output voltages.

With reference to FIGS. 1 and 2, the ratchet tool 10 includes a motor 44 with a motor shaft 48 rotatable about the axis A when the motor 44 is energized and a switch 56 for selectively connecting the motor 44 to the battery pack 26 (e.g., through circuitry of the switch 56 or through a control system receiving an input from the switch 56). A switch paddle 60 is coupled to the handle portion 13 to be manipulated by a user. When the switch paddle 60 is depressed toward the body of the housing portion 13, the switch 56 is compressed to energize the motor 44. The switch paddle 60 is pivotable about a rod 64. An elastic member 68 engages with the switch paddle 60 to bias the switch paddle 60 away from the switch 56. In some embodiments, the switch 56 is a variable-speed switch configured to control an operating speed of the motor 44. In some embodiments, other types of actuators (e.g., a trigger, push-button, or the like) may be provided for actuating the switch 56.

Referring to FIG. 2, the drive housing 14 at least partially encloses and supports a drive assembly 52 operatively coupled to the motor shaft 48. In some embodiments, the drive housing 14 may be an integral part of the handle portion 13 of the housing 12. In other embodiments, the drive housing 14 may be a separate component, optionally made of a different material (e.g., steel) than the material of the handle portion 13 (e.g., plastic). The illustrated drive assembly 52 is a planetary transmission including a pinion 50 (which may be integral with the motor shaft 48), a plurality of planet gears 54 meshed with the pinion 50, and a ring gear 58 meshed with the planet gears 54 such that rotation of the pinion 50 causes the planet gears 54 to orbit about an inner periphery of the ring gear 58. The drive assembly 52 includes an output 62, which in the illustrated embodiment is a planetary carrier coupled to the planet gears 54 (e.g., by pins). However, other types of drive assemblies may be used, and in some embodiments, the motor shaft 48 itself may define the output 62 of the drive assembly 52.

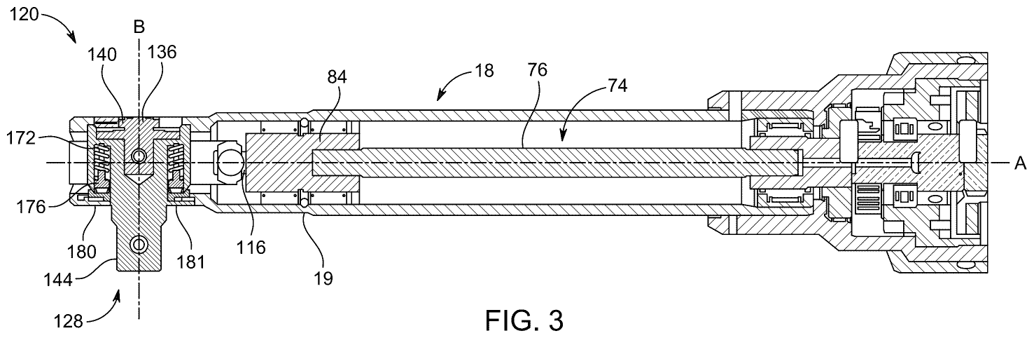

With reference to FIGS. 1-3, the head portion 18 supports an output assembly 120 configured to receive a tool bit, such as a socket, for engagement with a workpiece, such as a fastener. The output assembly 120 includes a yoke 124 having a plurality of yoke teeth 150 (FIG. 2), an anvil 128 having an output member 144 (FIG. 3), such as a square head for engaging sockets, a pawl 132 (FIG. 2), and a forward reverse switch 136 having a gripping actuator 140 that is accessible through the head portion 18. The anvil 128 is rotatable about a second axis B perpendicular to the first axis A. The gripping actuator 140 can be used to rotate the forward reverse switch 136 between a first position and a second position.

The yoke 124 is selectively engageable with the pawl 132 via a first set of pawl teeth 151 or a second set of pawl teeth 152. The pawl 132 is moveable, and, more specifically, pivotable, about a pawl pin 130. When the forward reverse switch 136 is in the first position, the pawl 132 is configured to engage the first set of pawl teeth 151 with the yoke teeth 150 to couple the anvil 128 for co-rotation with the yoke 124 in a first direction but to permit the yoke 124 to rotate relative to the anvil 128 in a second, opposite direction. When the forward reverse switch 136 is in the second position, the pawl 132 is configured to engage the second set of pawl teeth 152 with the yoke teeth 150 to couple the anvil 128 for co-rotation with the yoke 124 in the second direction but to permit the yoke 124 to rotate relative to the anvil 128 in the first direction.

Referring to FIG. 2-4, the ratchet tool 10 includes a shaft assembly 74 extending coupled for co-rotation with the output 62 of the drive assembly 52. The illustrated shaft assembly 74 is a multi-piece assembly including a shaft 76 having a first end 184 and a second end 188 opposite the first end 184, a first coupler 72 fixed to the first end 184 of the shaft 76, a second coupler 84 fixed to the second end 188 of the shaft 76, and a pin 116 fixed to the second coupler 84. As described in greater detail below, the shaft assembly 74 transmits a torque from the drive assembly 52 to the yoke 124 to pivotally reciprocate the yoke 124 about the axis B. In some embodiments, the shaft 76 is made of a relatively high-strength material, such as chromoly steel (e.g., 42CrMo steel) and is machined to a desired shape and size for the powered ratchet tool 10.

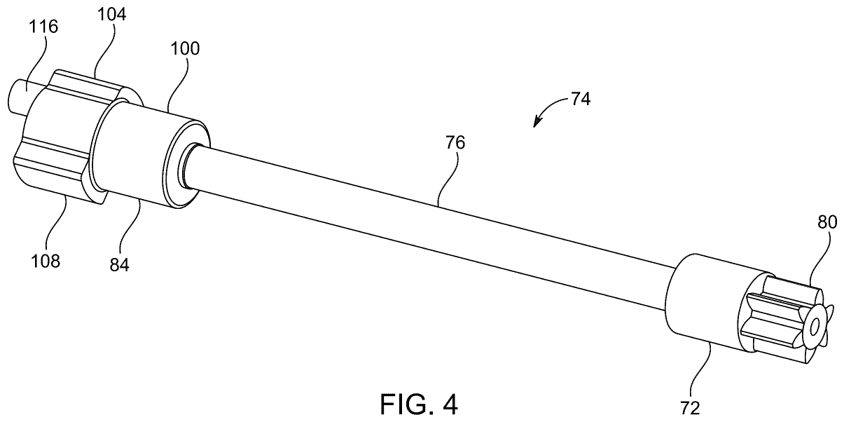

Best illustrated in FIG. 4, the illustrated first coupler 72 includes an interlocking feature, such as a spline 80 as illustrated or another geometric feature, such as a key, square or hex geometry, or the like, that cooperates with a corresponding interlocking feature (e.g., female spline) formed in the output 62 of the drive assembly 52 (FIG. 2). The first coupler 72 further includes a cylindrical portion 88 extending from the spline 80 and having a recess 90 opposite the spline 80. Because the first coupler 72 is formed separately from the shaft 76, the first coupler 72 may be made of a different material, a different manufacturing process, and/or have different material properties than the shaft 76. For example, the first coupler 72 in the illustrated embodiment is made of powdered metal via a suitable powdered metal manufacturing process, such as compaction and sintering. This may allow the relatively complex geometric features of the first coupler 72 (e.g., including the spline 80) to be produced in a less costly manner than machining or forging. In other embodiments, the second coupler 84 may be manufactured through traditional machining, casting, or some combination of machine, casting, and powered metallurgy.

Referring to FIG. 2, the recess 90 receives the first end 184 of the shaft 76 in a press-fit. However, the first coupler 72 may be coupled to the shaft 76 in other ways, such as welding, brazing, mechanical fasteners, etc. In this way, the first coupler 72 couples the shaft 76 to the output 62 for co-rotation therewith about the axis A. The cylindrical portion 88 of the first coupler 72 is supported for rotation about the axis A by a bearing 92.

Referring to FIGS. 2 and 4, the illustrated second coupler 84 includes a cylindrical portion 100 with a recess 102, a first wing 104 and a second wing 108 extending from the cylindrical portion 100, and an eccentric recess 111 that defines a third axis C parallel to the first axis A. The pin 116 is press-fit (or otherwise fixed) within the eccentric recess 111 such that the pin 116 extends along the third axis C. A drive bushing 156 is coupled to the pin 116 and received within a drive recess 164 formed in the yoke 124. The recess 102 receives the second end 188 of the shaft 76 in a press-fit. However, the second coupler 84 may be coupled to the shaft 76 in other ways, such as welding, brazing, mechanical fasteners, etc. The cylindrical portion 100 of the second coupler 84 is supported for rotation about the axis A by a bearing 112. Due to the eccentric position of the pin 116 (i.e., offset from the first axis A), rotation of the shaft 76 about the first axis A causes the yoke 124 to pivotally reciprocate about the second axis B. The wing 104 provides additional material thickness for the eccentric recess 111 to accommodate the pin 116, and the wing 108 is sized to balance the second coupler 84 and minimize vibrations. Specifically, the size and shape of the wing 108 is selected to ensure that the center of mass of the second coupler 84 is intersected by the first axis A1 to minimize vibration during rotation of the shaft assembly 74. Like the first coupler 72, the second coupler 84 may be made of powdered metal by a suitable powdered metal process. In other embodiments, the second coupler 84 may be manufactured through traditional machining, casting, or some combination of machine, casting, and powered metallurgy.

In operation, the shaft assembly 74 rotates about the first axis A and transmits torque from the motor 44 (via the drive assembly 52) to the yoke 124 to reciprocate the yoke 134 about the second axis B. Depending on the position of the pawl 132 and the forward reverse switch 136, the anvil 128 will be driven in either a first rotational direction or a second rotational direction. The multi-piece construction of the shaft assembly 74 advantageously permits components of the shaft assembly 74 to be made of different materials and/or by different manufacturing processes. For example, instead of forging the shaft assembly 74 as a single piece of steel, which may be difficult and costly due to the complex geometry of the shaft assembly 74, the first and second couplers 72, 84 may be made from powdered metal, or in other ways that provide greater manufacturing efficiency for complex shapes. The remaining shaft 76 and pin 116 can then have simple cylindrical shapes formed in a variety of ways using solid steel. The couplers 72, 84 may have different hardnesses than the shaft 76 and pin 116 in some embodiments. For example, one or both couplers 72, 84 may have a lower hardness than the shaft 76 and the pin 116.

Although the disclosure has been described in detail with reference to certain preferred embodiments, variations and modifications exist within the scope and spirit of one or more independent aspects of the disclosure as described.

Various features of the disclosure are set forth in the following claims.

What is claimed is:

1. A powered ratchet tool comprising:
a housing including a head portion;
a drive assembly including an output rotatable about a first axis;
a yoke supported within the head portion and pivotable about a second axis perpendicular to the first axis;
an anvil extending from the head portion and configured to engage a socket;
a pawl moveable between a first position, in which the pawl couples the anvil for co-rotation with the yoke in a first direction about the second axis, and a second position, in which the pawl couples the anvil for co-rotation with the yoke in a second direction about the second axis; and
a shaft assembly extending between the output of the drive assembly and the yoke, the shaft assembly formed as a multi-piece construction, the shaft assembly including:
a shaft extending along the first axis and having a first end and a second end opposite the first end,
a first coupler fixed to the first end of the shaft, the first coupler configured to couple the shaft assembly for co-rotation with the output of the drive assembly about the first axis,
a second coupler fixed to the second end of the shaft, and
a pin extending from the second coupler to the yoke, wherein the pin is offset from the first axis such that rotation of the shaft assembly about the first axis causes reciprocation of the yoke about the second axis.

2. The powered ratchet tool of claim 1, wherein the first coupler is made of powdered metal.

3. The powered ratchet tool of claim 1, wherein the second coupler is made of powdered metal.

4. The powered ratchet tool of claim 1, wherein the drive assembly includes a motor and a planetary transmission and wherein the output is a carrier of the planetary transmission.

5. The powered ratchet tool of claim 4, wherein the first coupler includes a spline, and wherein the spline is received within the carrier of the planetary transmission.

6. The powered ratchet tool of claim 1, wherein the shaft is made of chromoly steel.

7. The powered ratchet tool of claim 1, wherein the yoke receives a bushing, and wherein the bushing receives the pin of the shaft assembly.

8. The powered ratchet tool of claim 1, wherein the second coupler includes a recess to receive the pin, a first wing, and a second wing, wherein the recess is formed at least partially in the second wing, and wherein the first wing and the second wing are sized differently so the first axis intersects a center of mass of the second coupler.

9. A powered ratchet tool comprising:
a housing including a head portion;
a drive assembly;
a yoke supported within the head portion; and
a shaft assembly extending between an output of the drive assembly and the yoke, the shaft assembly including:
a shaft extending along a first axis and having a first end and a second end opposite the first end, the shaft formed by a first manufacturing process,
a first coupler fixed to the first end of the shaft, the first coupler configured to couple the shaft assembly for co-rotation with the output of the drive assembly, the first coupler formed by a second manufacturing process, and
a second coupler fixed to the second end of the shaft, the second coupler formed by a third manufacturing process,
wherein at least one of the second manufacturing process or the third manufacturing process is different than the first manufacturing process.

10. The powered ratchet tool of claim 9, wherein the shaft assembly includes a pin extending from the second coupler, wherein the pin is offset from the first axis such that rotation of the shaft assembly about the first axis causes reciprocation of the yoke about a second axis.

11. The powered ratchet tool of claim 9, wherein at least one of the second manufacturing process or the third manufacturing process is a powdered metal manufacturing process.

12. The powered ratchet tool of claim 9, wherein the second manufacturing process and the third manufacturing process are the same manufacturing processes.

13. The powered ratchet tool of claim 9, wherein the first coupler and the second coupler have a different hardness than the shaft.

14. The powered ratchet tool of claim 9, wherein the first manufacturing process includes machining.

15. The powered ratchet tool of claim 9, wherein the shaft is made of chromoly steel.

16. A powered ratchet tool comprising:
a housing including a head portion;
a drive assembly including an output rotatable about a first axis;
a yoke supported within the head portion and pivotable about a second axis perpendicular to the first axis;
an anvil extending from the head portion and configured to engage a socket;
a pawl moveable between a first position, in which the pawl couples the anvil for co-rotation with the yoke in a first direction about the second axis, and a second position, in which the pawl couples the anvil for co-rotation with the yoke in a second direction about the second axis; and
a shaft assembly extending between the output of the drive assembly and the yoke, the shaft assembly formed as a multi-piece construction, the shaft assembly including:
a shaft extending along the first axis and having a first end and a second end opposite the first end,
a first coupler configured to couple the shaft assembly for co-rotation with the output of the drive assembly about the first axis,
a second coupler, and
a pin extending from the second coupler to the yoke, wherein the pin is offset from the first axis such that rotation of the shaft assembly about the first axis causes reciprocation of the yoke about the second axis,
wherein the shaft is made of a first material, and
wherein at least one of the first coupler or the second coupler is made of a second material different than the first material.

17. The powered ratchet tool of claim 16, wherein the shaft is made of forged steel.

18. The powered ratchet tool of claim 16, wherein both the first coupler and the second coupler are made of the second material.

19. The powered ratchet tool of claim 16, wherein the pin is made of forged steel.

20. The powered ratchet tool of claim 16,
wherein the drive assembly includes a motor and a planetary transmission,
wherein the output is a carrier of the planetary transmission,
wherein the first coupler includes a spline,
wherein the spline is received within the carrier of the planetary transmission, and
wherein the shaft is pressed into a recess of the first coupler.
